(19) United States
(12) Patent Application Publication
(10) Pub. No.: US 2012/0320367 A1
(43) Pub. Date: Dec. 20, 2012

(54) INSPECTION METHOD AND DEVICE FOR SAME

(75) Inventors: Yu Yanaka, Kamisato (JP); Shigeru Serikawa, Kamisato (JP); Kiyotaka Horie, Kamisato (JP); Ryuta Suzuki, Kamisato (JP)

(73) Assignee: HITACHI HIGH-TECHNOLOGIES CORPORATION, Tokyo (JP)

(21) Appl. No.: 13/577,287

(22) PCT Filed: Feb. 1, 2011
(86) PCT No.: PCT/JP2011/052050

§ 371 Date: Aug. 6, 2012

(30) Foreign Application Priority Data
Mar. 11, 2010 (JP) 2010-054437

(51) Int. Cl. G01J 3/42

(52) U.S. Cl. 356/51; 356/306

(57) ABSTRACT

In order to rapidly inspect shape defects in the object of inspection that is the minute pattern on a magnetic recording medium formed from patterned media, in the disclosed patterned media defect inspection method detected spectral waveform data is compared with reference-standard spectral reflectance waveform data, which is stored in a database and the pattern-shape of which is known, and defects are detected. The type of the defects is determined on the basis of the disparity, for each detected wavelength, between the spectral waveform data of the detected defects, and the reference-standard spectral reflectance waveform data.

### BACKGROUND

The present invention relates to an inspection method and a device for the same for determining right or wrong of a pattern shape, and particularly to an inspection technique that discriminates a shape depending on a difference in the wavelength of the spectral waveform of reflected light from a pattern formed on a patterned medium and determines right or wrong of the pattern shape.

The recording capacity of hard disks has been increased for years. As one of techniques for increasing the capacity, patterned media are expected to be introduced. The patterned media are classified into two types, namely, discrete track media and bit patterned media. In the technique of the discrete track media, concentric track patterns are formed on media disks. In the technique of the bit patterned media, countless bit patterns are formed.

The patterned media are formed by physically forming the patterns on the surface of a disk to record magnetic information on the formed patterns. Since physical spaces are formed between the adjacent patterns, the recording density can be increased more than before.

In order to form the patterns, a method using the nanoimprint technology is most likely to be employed. However, in the case where the sizes and shapes of the patterns vary, magnetic recording media do not correctly operate and malfunction as defects in some cases. Therefore, it is necessary to inspect whether the pattern shape is properly formed.

As a conventional inspection method for detecting defects on the surface of a disk, there is a method described in Patent Literature 3. In this method, laser light is irradiated onto the surface of a disk to discriminate (concave-convex determination) defects on the basis of a signal obtained from a light-receiving element that detects scattering light and regular reflected light.

Each of Patent Literature 1 and 2 describes an invention related to inspecting the surface of a patterned medium by spectral detection while allowing a spindle to rotate at relatively-low speeds. On the other hand, Patent Literature 3 describes an invention related to inspecting defects on the surface of a disk while allowing a spindle to rotate at high speeds to scan the surface of the disk in a spiral manner.

### CITATION LIST

### Patent Literature

Patent Literature 1: Japanese Patent Application Laid-Open Publication No. 2009-257993
Patent Literature 2: Japanese Patent Application Laid-Open Publication No. 2009-150832
Patent Literature 3: Japanese Patent Application Laid-Open Publication No. 2008-268189

### SUMMARY OF THE INVENTION

In Patent Literature 1 and 2, a detailed inspection of a minute pattern formed on the surface of a disk such as a patterned medium can be realized. However, it takes time to process a detected signal, and it is difficult to apply to an actual production line in which a large amount of disks need to be processed in a short takt time.

Further, the invention described in Patent Literature 3 relates to a technique to detect defects or foreign matters on the surface of a flat disk by detecting scattering light. In Patent Literature 3, an inspection of defects of a minute pattern shape is not considered.

An object of the present invention is to provide a pattern shape inspection method and a device for the same in which defects of the minute pattern shape of a magnetic recording medium such as a patterned medium used as an inspection target can be inspected at high speeds.

In order to achieve the above-described object, the present invention can determine the width and height of a pattern and the thickness of a base by comparing detected spectral waveform data with waveform data stored in advance in a defect inspection method for patterned media.

Specifically, the present invention provides an inspection device including: a rotational axis unit that holds a sample on the surface of which a pattern is formed and rotates the held sample; a conveying unit that conveys the rotational axis unit holding the sample to an inspection position; a spectral detection optical system unit that irradiates a light spot containing plural wavelengths onto the sample conveyed to the inspection position by the conveying unit while being held by the rotational axis unit and carrying out spectral detection of reflected light from an area on the sample onto which the light spot is irradiated; and a signal processing unit that processes a signal obtained by spectral detection of the reflected light from the sample by the spectral detection optical system unit to determine defects of the pattern on the sample and the type of defects, the signal processing unit including: spectral reflectivity data obtaining means that processes the signal obtained by the spectral detection of the reflected light by the spectral detection optical system unit to obtain spectral reflectivity data; database means that stores spectral reflectivity data of reflected light from a normal pattern and spectral reflectivity data of reflected light from a pattern whose differences from the normal pattern are allowable; data processing means that compares the spectral reflectivity data obtained by the spectral reflectivity data obtaining means with the spectral reflectivity data stored in the database means to extract data in which the amount of differences from the spectral reflectivity data stored in the database means exceeds an allowable range; and defect determination means that determines defects of the pattern on the sample and the type of defects using information of the data which is extracted by the data processing means and in which the amount of differences from the spectral reflectivity data stored in the database means exceeds an allowable range.

Further, the present invention provides an inspection method including the steps of: holding a sample on the surface of which a pattern is formed with a rotational axis unit; conveying the rotational axis unit holding the sample to an inspection position; irradiating a light spot containing plural wavelengths onto the sample conveyed to the inspection position while being held by the rotational axis unit and the spectral detection of reflected light from an area on the sample onto which the light spot is irradiated; and determining defects of the pattern on the sample and the type of defects by processing a signal obtained by the spectral detection of the reflected light from the sample, wherein the defects of the pattern on the sample and the type of defects are determined by comparing spectral reflectivity data obtained by the spectral detection of the reflected light with spectral reflectivity data stored in advance to extract data in which the amount of differences from the spectral reflectivity data stored in advance exceeds an allowable range and by using information of the data in which the amount of differences from the spectral reflectivity data extracted and stored in advance exceeds an allowable range.

According to an aspect of the present invention, in the case where defects of a pattern shape on a patterned medium are detected to specify the type of defects, the amount of data to be handled can be reduced, a real-time process can be realized by shortening the data processing time, and a data processing unit can be reduced in size and weight.

These features and advantages of the invention will be apparent from the following more particular description of preferred embodiments of the invention, as illustrated in the accompanying drawings.

### BRIEF DESCRIPTION OF THE DRAWINGS

FIG. 1 is a block diagram for showing an outline configuration of an inspection device.

FIG. 2 is a flowchart for explaining an operational flow of the inspection device.

FIG. 3 is a block diagram for showing an outline configuration of an optical system.

FIG. 4 is a cross-sectional view of a disk on which a pattern is formed.

FIG. 5 is a graph for showing an example of results of measuring spectral reflectivity distribution.

FIG. 6 is a flowchart for explaining an inspection flow of the surface of a disk.

FIG. 7 is a front view of a screen for showing an example of displaying an inspection result.

### DESCRIPTION OF EMBODIMENTS

A hard disk inspection device according to the present invention will be described using the drawings.

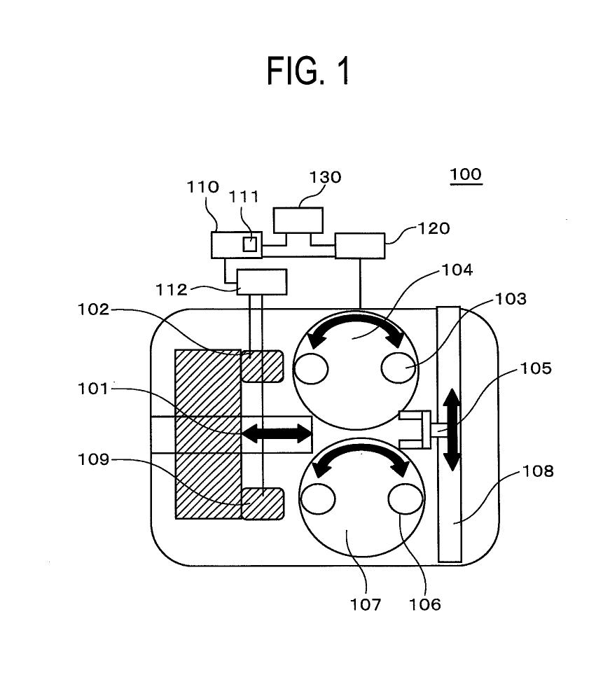

FIG. 1 shows an outline configuration of a hard disk inspection device 100 according to the present embodiment. The inspection device includes: a spectral detection optical system 102 that irradiates detection light onto a hard disk (hard disk medium) 207 as an inspection target on the surface of which a resist pattern is formed and carries out a spectrum detection on a reflected light from the inspection target; a spindle unit 103 that holds the inspection target and rotates at high speeds; a turntable unit 104 that turns the spindle unit to position at the conveying side and at the optical system side; an optical stage unit 101 that allows an optical system to scan on the inspection target; an inversion unit 105 that inverts the inspection target; a control unit 120 that controls the operations of the spectral detection optical system 102, the spindle unit 103, the turntable unit 104, the optical stage unit 101, and the inversion unit 105; a data processing unit 110 that detects the shape or shape abnormality of the pattern formed on the surface of the inspection target on the basis of spectral detection data; and a spectral waveform processing unit 112 that processes an output signal from the spectral detection optical system 102. The data processing unit 110 is provided with a display unit 111.

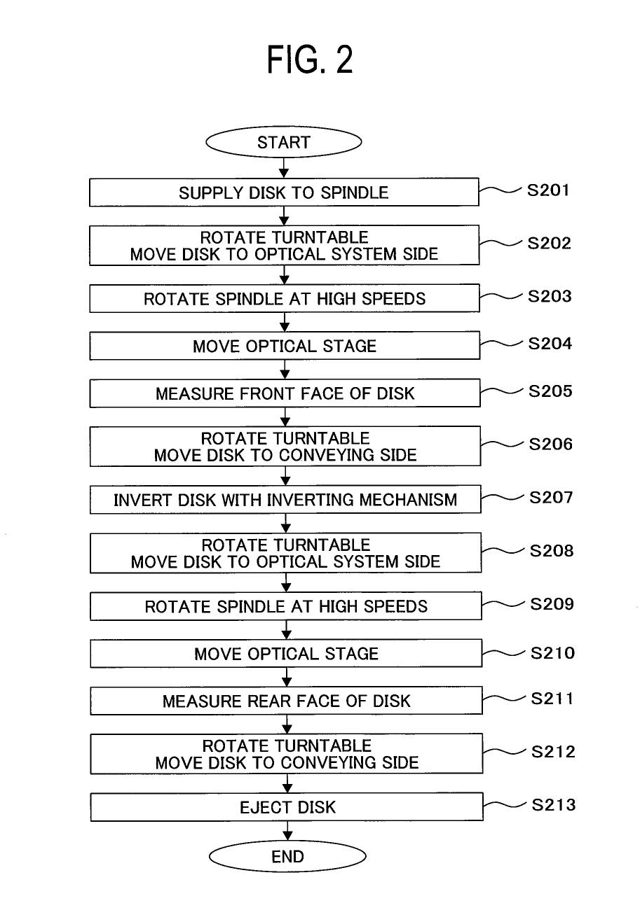

A procedure of inspecting the resist pattern formed on the surface of the hard disk medium 207 using the hard disk inspection device 100 shown in FIG. 1 will be described using the flowchart of FIG. 2.

First, the hard disk medium 207 as an inspection target is supplied and fixed to the spindle unit 103 using a handling unit (not shown) (S201). Next, the turntable 104 rotates by 180 degrees and the spindle unit 103 moves to the side of the spectral detection optical system 102 for front-face inspection (S202). The spindle unit 103 having moved to the side of the spectral detection optical system 102 for front-face inspection starts to rotate at high speeds (S203), and the hard disk medium 207 as an inspection target fixed to the spindle unit 103 is rotated at high speeds. The optical stage 101 is allowed to move in synchronization with the high-speed rotation of the spindle unit 103 (S204), so that the front face of the hard disk medium 207 is entirely scanned in a spiral manner (S205). The inspection data obtained by the spectral detection optical system 102 for front-face inspection is processed by the data processing unit 110 to determine the pattern shape and the like, and the determination result is displayed on the display unit 111.

When the inspection of the front face of the hard disk medium 207 is completed, the turntable 104 rotates to turn the spindle unit 103 on which the hard disk medium 207 is held to the conveying side at which the hard disk medium 207 is supplied by the handling unit (not shown) (S206). Next, the hard disk medium 207 is inverted by the inversion unit 105 and moved to the adjacent turntable 107 along a guide rail 108, and is supplied and fixed to a spindle unit 106 (S207). After the hard disk medium 207 is fixed to the spindle unit 106, the turntable 107 rotates by 180 degrees to place the hard disk medium 207 at the side of a spectral detection optical system 109 for rear-face inspection (S208).

The spindle unit 106 having moved to the side of the spectral detection optical system 109 for rear-face inspection starts to rotate at high speed (S209) to allow the hard disk medium 207 as an inspection target fixed to the spindle unit 106 to rotate at high speeds. The optical stage 101 moves in synchronization with the high-speed rotation of the spindle unit 106 (S210), so that the rear face of the hard disk medium 207 is entirely scanned in a spiral manner (S211). The inspection data obtained by the spectral detection optical system 109 for rear-face detection is processed by the data processing unit 110 to determine the pattern shape and the like, and the determination result is displayed on the display unit 111.

When the inspection of the rear face of the hard disk medium 207 is completed, the turntable 107 rotates to turn the spindle unit 107 to the conveying side at which the hard disk medium 207 is supplied by the handling unit (not shown) (S212). Then, the hard disk medium 207 is taken out from the spindle 107 of the hard disk inspection device 100 by the handling unit (not shown) (S213).

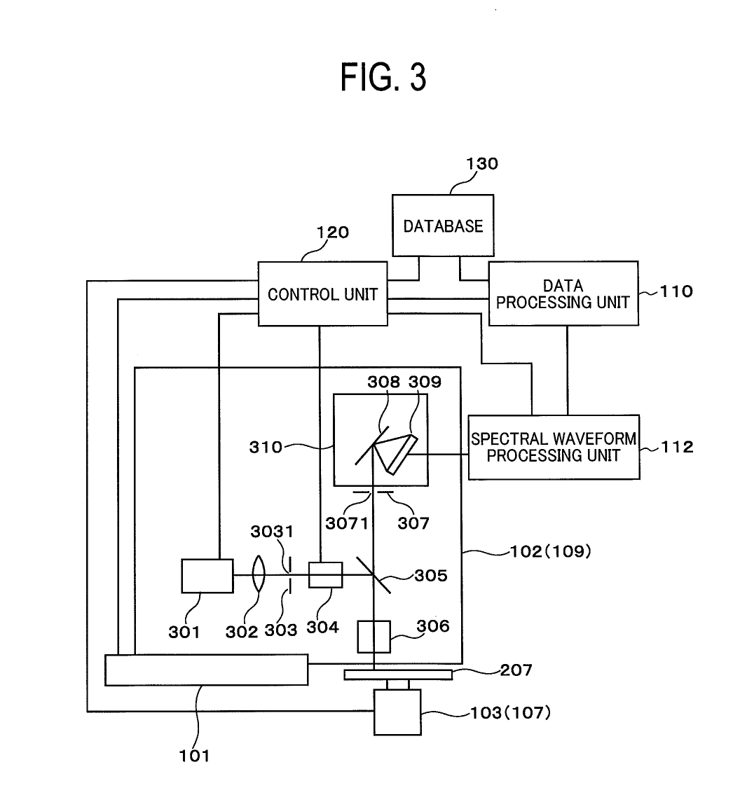

Next, configurations of the spectral detection optical system 102 for front-face inspection and the spectral detection optical system 109 for rear-face inspection will be described using FIG. 3.

The spectral detection optical system 102 (109) is fixed on the optical stage 101 as shown in FIG. 3, and includes: a light source 301 that emits broadband light containing deep ultraviolet (DUV) light; a collecting lens 302 that collects the light emitted from the light source 301; a field diaphragm 303 with an opening part 3031 that determines a detection field on the hard disk medium 207 as an inspection target held by the spindle 103 (107); a polarization control unit 304 that allows illumination light to polarize in a specific direction so as to be suitable for the inspection of the hard disk medium 207; a half mirror 305 that bends the optical path of the polarized illumination light towards the hard disk medium 207; an objective lens 306 that collects the illumination light on the surface of the hard disk medium 207; a diaphragm 307 with an opening part 3071 that allows the reflected light having been reflected from the surface of the hard disk medium 207 by the illumination of the illumination light, collected by the objective lens 306 again, and passed through the half mirror 305, so that stray light from the surrounding areas is cut; and a spectroscope 310 having a diffraction grating 308 that carries out a spectral detection of light having passed through the opening part 3071 of the diaphragm 307 and a linear light detector 309 in which plural detection pixels that detect the spectral waveforms of light which is carried out the spectrum by the diffraction grating 308 are linearly arranged.

A spectral waveform signal detected by the linear light detector 309 of the spectroscope 310 is transmitted to the spectral waveform processing unit 112 for A/D conversion, and then is transmitted to the data processing unit 110 to be processed, so that the pattern shape of the hard disk medium 207 is inspected.

Next, a method of inspecting the pattern shape with the spectral detection optical system 102 (109) having the configuration shown in FIG. 3 will be described.

First, the optical stage 101 is set at the inspection start position under the control of the control unit 120, and the spindle 103 (107) rotates at high speeds, so that the optical stage 101 moves in one direction at a constant speed in a state where the hard disk medium 207 held by the spindle 103 (107) is rotating at high speeds. The light source 301 controlled by the control unit 120 emits broadband (multi-wavelength) illumination light (for example, a wavelength of 200 to 800 nm) containing deep ultraviolet (DUV) light. As the light source 301, an Xe lamp, a halogen lamp, a deuterium lamp, a mercury lamp, or the like can be used.

The light emitted from the light source 301 is collected at the position of the opening part 3031 of the field diaphragm 303 by the collecting lens 302. The image of the light collected at the opening part 3031 of the field diaphragm 303 is formed on the surface of the hard disk medium 207 by the objective lens 306. Further, the illumination light having passed through the opening part 3031 of the field diaphragm 303 is adjusted to a polarization state preset by the polarization control unit 304 controlled by the control unit 120. Then, a part of the illumination light is reflected in the direction of the objective lens 306 by the half mirror 305, passes through the objective lens 306 and is irradiated onto the hard disk medium 207. For the control of the polarization state by the polarization control unit 304, the polarization direction of the illumination light is obtained beforehand the inspection and stored in the database unit 130 on the basis of the conditions under which high-sensitive measurement of the pattern shape formed on the hard disk medium 207 is performed, so that the optimum polarization conditions can be set in accordance with an inspection target

The reflected light from the hard disk medium 207 on which the image of the opening part 3031 of the field diaphragm 303 is projected enters the objective lens 306 again, and a part thereof passes through the half mirror 305 to reach the diaphragm 307. By adjusting the position of the field diaphragm, the image of the reflected light from the hard disk medium 207 and passes through the objective lens is formed at the position of the opening part 3071 of the diaphragm 307. The size of the opening part 3071 of the diaphragm 307 is adjusted to that of the detection field (an area where the image of the opening part 3031 of the field diaphragm 303 is projected) on the hard disk medium 207, so that stray light or light that is not imaged on the diaphragm 307 can be blocked.

The reflected light (regular reflected light) from the detection field on the hard disk medium 207 having passed through the opening part 3071 of the diaphragm 307 reaches the diffraction grating 308 of the spectral optical system 310 to become spectral waveforms diffracted in accordance with the wavelengths by the diffraction grating 308. Then, the spectral waveforms are detected on a wavelength basis by the linear light detector 309 in which plural detecting elements are arranged. The spectral waveform detection signal detected by the linear light detector 309 is input to the spectral waveform processing unit 112 for A/D conversion to obtain a digitalized spectral reflectivity waveform. The digitalized spectral reflectivity waveform is transmitted to the data processing unit 110 to be processed, and the pattern shape formed on the hard disk medium 207 is inspected.

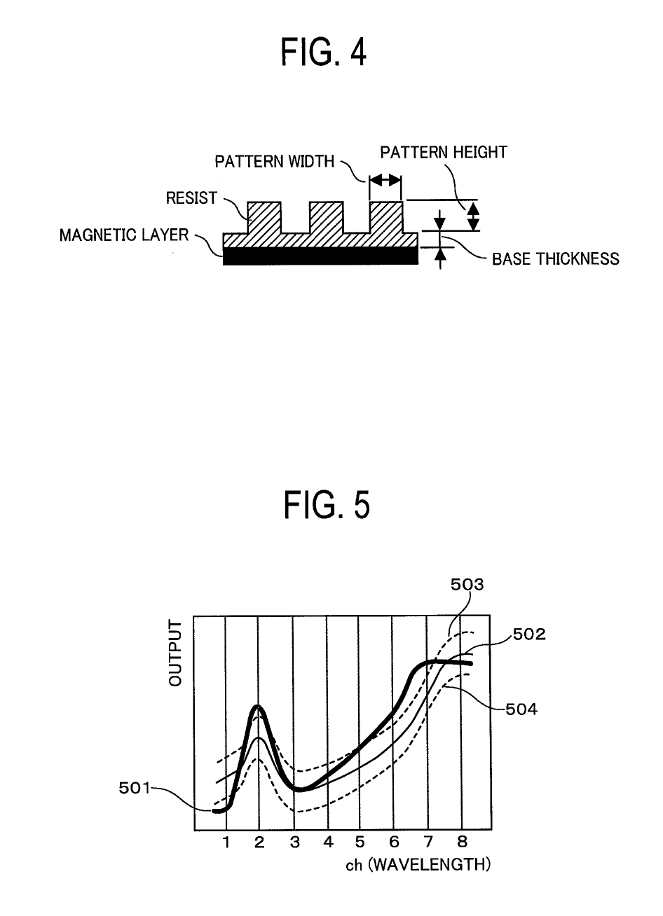

Next, an inspection method of the pattern shape executed by the data processing unit 110 will be described. First, spectral reflectivity waveform data of a standard sample which has a normal concave-convex pattern and whose pattern shape is already known is preliminarily obtained to be stored in the database unit 130. In addition, a spectral reflectivity waveform in the case where a concave-convex pattern shape (the height and width of the resist pattern and the thickness of the base as shown in FIG. 4) is changed is obtained by an electromagnetic wave analysis on the basis of the spectral reflectivity waveform data of the standard sample to be stored in the database unit 130. At the same time, spectral reflectivity waveform data associated with the limit value of differences in the concave-convex pattern shape is determined to be registered in the database unit 130. Specifically, as shown in FIG. 5, spectral reflectivity waveform data 502 of the normal concave-convex pattern and spectral reflectivity waveform data 503 and 504 associated with the limit of allowable differences in the concave-convex pattern shape are registered in the database unit 130. It should be noted that the horizontal axis represents a channel (ch) number of the detector associated with a detected wavelength in FIG. 5, and the channel number is associated with a detected wavelength. As the number increases, the detected wavelength is long.

The spectral reflectivity waveform is differently changed, for example, between a case in which the height of the concave-convex pattern shape is changed and a case in which the width thereof is changed. Specifically, the spectral reflectivity waveform differs in accordance with the cause of defects of the concave-convex pattern shape. With the use of the characteristics, a relation between the cause of defects of the concave-convex pattern shape and characteristics of the spectral reflectivity waveform is preliminarily registered in the database unit 130. Then, the spectral reflectivity waveform data obtained by inspecting the inspection target sample is compared with that of the standard sample to obtain distribution characteristics of wavelength bands which are out of an allowable value. On the basis of information of the relation between the cause of defects of the concave-convex pattern shape and characteristics of the spectral reflectivity waveform registered in the database unit 130, defects of the pattern shape of the inspection target sample can be detected and the type of defects can be specified.

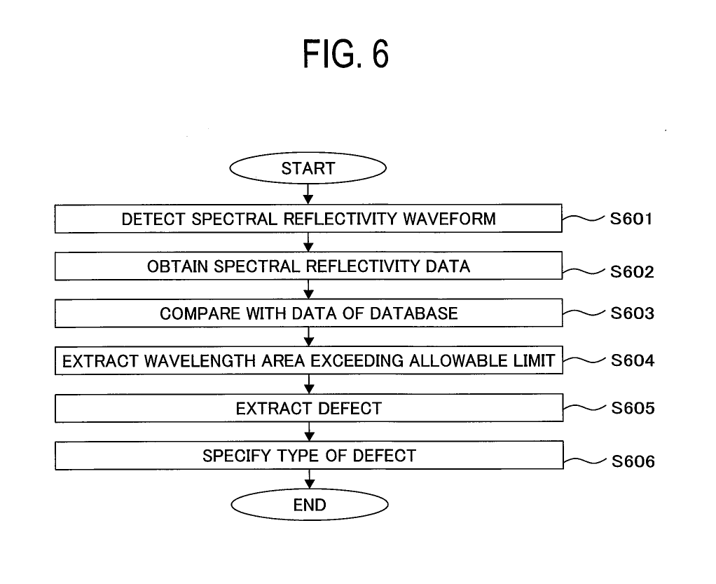

A processing flow (processes of S205 and S211 in FIG. 2) in an actual inspection will be described using FIG. 6. A spectral reflectivity waveform is detected with the spectral detection optical system 102 (109) having the configuration shown in FIG. 3 using the hard disk medium 207 as an inspection target (S601) to obtain the spectral reflectivity data as shown by 501 of FIG. 5 (S602). Next, the measurement data 501, the spectral reflectivity waveform data 502 of the normal concave-convex pattern and the spectral reflectivity waveform data 503 and 504 associated with the limit of allowable differences in the concave-convex pattern shape are compared with each other (S603), and a part of the measurement data 501 out of range between the spectral reflectivity waveform data 503 and 504 associated with the limit of allowable differences in the concave-convex pattern shape is extracted (S604). Next, on the basis of information of the extracted wavelength bands of the measurement data 501, defects of the pattern shape of the inspection target sample are detected (S605) and the type of defects is specified (S606) from the information of the relation between the cause of defects of the concave-convex pattern shape and characteristics of the spectral reflectivity waveform registered in the database unit 130.

Since a part of the detected spectral reflectivity waveform data which is out of the range between the spectral reflectivity waveform data 503 and 504 associated with the limit of allowable differences in the concave-convex pattern shape is extracted and processed as described above, the amount of data to be handled can be decreased as compared with a case in which all the detected spectral reflectivity waveform data is processed to detect the defects of the pattern shape and the type of defects is specified. In addition, real-time processing can be realized by shortening the data processing time, and the data processing unit 110 can be reduced in size and weight.

It should be noted that there has been described a case in which the resist pattern shape formed on the patterned media is inspected in the above-described embodiment. However, the embodiment can be applied to a case in which the pattern shape of a magnetic film formed by etching using a resist pattern as a mask is inspected.

For example, as shown in FIG. 5, in the case where the measurement result 501 is below the lower slice level 504 at ch1 and above the upper slice level 503 at ch2, ch6, and ch7, it can be determined that the pattern width is larger than a standard by referring to the relation between the cause of defects of the concave-convex pattern shape and characteristics of the spectral reflectivity waveform registered in the database unit 130.

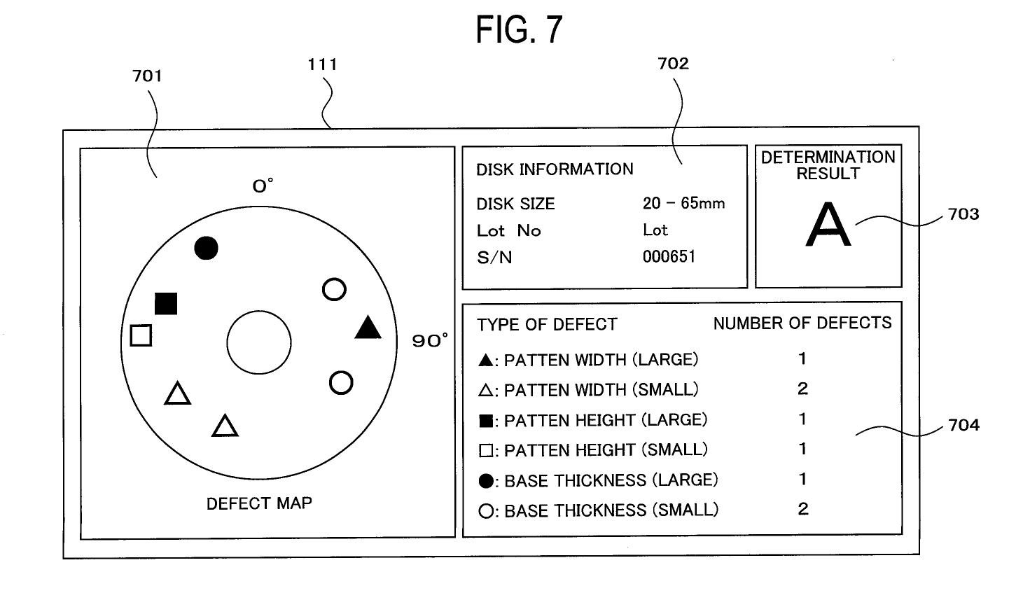

An example of displaying the determination result on the display screen 111 of the data processing unit 110 is shown in FIG. 7. On the display screen 111, displayed are a defect map 701 on the hard disk medium, the number of defects 704, a determination result 703, and disk information 702. The defects are shown by dots in the example of FIG. 7. However, distribution based on the type of defects may be displayed by areas.

As a result, for example, the abnormality of the pattern shape of the patterned medium can be detected at high speeds by the inspection device of the embodiment.

The invention may be embodied in other specific forms without departing from the spirit or essential characteristics thereof. The present embodiment is therefore to be considered in all respects as illustrative and not restrictive, the scope of the invention being indicated by the appended claims, rather than by the foregoing description, and all differences which come within the meaning and range of equivalency of the claims are therefore intended to be embraced therein.

### INDUSTRIAL APPLICABILITY

The present invention is applied to an inspection device that discriminates a shape depending on a difference in the wavelength of the spectral waveform of reflected light from a pattern formed on a patterned medium that is a kind of magnetic disks and determines right or wrong of the pattern shape.

1. An inspection device comprising:
a rotational axis unit that holds a sample on a surface of which a pattern is formed and rotates the held sample;
a conveying unit that conveys the rotational axis unit holding the sample to an inspection position;
a spectral detection optical unit that irradiates a light spot containing a plurality of wavelengths onto the sample conveyed to the inspection position by the conveying unit while being held by the rotational axis unit and carry out a spectral detection of reflected light from an area on the sample onto which the light spot is irradiated; and
a signal processing unit that processes a signal obtained by the spectral detection of the reflected light from the sample by the spectral detection optical unit to determine defects of the pattern on the sample and the type of defects,
the signal processing unit including:
spectral reflectivity data obtaining means that processes the signal obtained by the spectral detection of the reflected light by the spectral detection optical unit to obtain spectral reflectivity data;
database means that stores spectral reflectivity data of reflected light from a normal pattern and spectral reflectivity data of reflected light from a pattern whose differences from the normal pattern are allowable;
data processing means that compares the spectral reflectivity data obtained by the spectral reflectivity data obtaining means with the spectral reflectivity data stored in the database means to extract data in which the amount of differences from the spectral reflectivity data stored in the database means is out of an allowable range; and
defect determination means that determines defects of the pattern on the sample and the type of defects using information of the data which is extracted by the data processing means and in which the amount of differences from the spectral reflectivity data stored in the database means is out of an allowable range.

2. The inspection device according to claim 1, wherein
the data processing means compares the spectral reflectivity data obtained by the spectral reflectivity data obtaining means with the spectral reflectivity data that is stored in the database means and is obtained by the spectral detection of the reflected light from the normal pattern and the spectral reflectivity data obtained by the spectral detection of the reflected light from the pattern whose differences from the normal pattern are allowable, and extracts, among the spectral reflectivity data obtained by the spectral detection of the reflected light, spectral reflectivity data which is out of range of the spectral reflectivity data of the stored pattern whose differences from the normal pattern are allowable.

3. The inspection device according to claim 1, further comprising a stage unit on which the spectral detection optical system unit is mounted and which moves the spectral detection optical system unit in the radius direction of the sample held by the rotational axis.

4. The inspection device according to claim 1, wherein
two sets of the rotational axis unit, the conveying unit, and the spectral detection optical unit are provided, and there is further provided a sample inversion unit that removes a sample from the rotational axis unit for which an inspection is completed by the spectral detection optical unit of one set and inverts the same to allow the rotational axis unit of the other set to hold the same.

5. The inspection device according to claim 1, wherein
the spectral detection optical unit includes light irradiation means that irradiates a light spot with wavelength bands ranging from visible light to deep ultraviolet light onto the sample.

6. The inspection device according to claim 1, wherein
the pattern formed on the surface of the sample is a resist pattern.

7. The inspection device according to claim 1, wherein
the defect determination means determines defects related to the width and height of the pattern and the thickness of a base as the type of defects.

8. An inspection method comprising:
holding a sample on the surface of which a pattern is formed with a rotational axis unit;
conveying the rotational axis unit holding the sample to an inspection position;
irradiating a light spot containing a plurality of wavelengths onto the sample conveyed to the inspection position while being held by the rotational axis unit and carrying out spectral detection of the reflected light from an area on the sample onto which the light spot is irradiated; and
determining defects of the pattern on the sample and the type of defects by processing a signal obtained by the spectral detection of the reflected light from the sample, wherein
the defects of the pattern on the sample and the type of defects are determined by comparing spectral reflectivity data obtained by the spectral detection of the reflected light with spectral reflectivity data stored in advance to extract data in which the amount of difference from the spectral reflectivity data stored in advance is out of an allowable range, and by using information of the extracted spectral reflectivity data which is out of the allowable range.

9. The inspection method according to claim 8, wherein
the data in which the amount of differences from the spectral reflectivity data stored in advance is out of an allowable range is extracted by comparing the spectral reflectivity data obtained by the spectral detection of the reflected light with spectral reflectivity data that is stored in advance and is obtained by the spectral detection of reflected light from a normal pattern and spectral reflectivity data obtained by the spectral detection of reflected light from a pattern whose differences from the normal pattern are allowable and by extracting, among the spectral reflectivity data obtained by the spectral detection of the reflected light, spectral reflectivity data which is out of the spectral reflectivity data of the stored pattern whose differences from the normal pattern are allowable.

10. The inspection method according to claim 8, wherein
the light irradiated onto the sample is light with wavelength bands ranging from visible light to deep ultraviolet light.

11. The inspection method according to claim 8, wherein
the pattern formed on the surface of the sample is a resist pattern.

12. The inspection method according to claim 8, wherein
defects related to the width and height of the pattern and the thickness of a base are determined as the type of defects of the pattern on the sample
